(19) United States
(12) Patent Application Publication
(10) Pub. No.: US 2026/0172121 A1
(43) Pub. Date: Jun. 18, 2026

(54) QUANTUM KEY DISTRIBUTION DEVICE, QUANTUM KEY DISTRIBUTION METHOD, AND NON-TRANSITORY COMPUTER READABLE MEDIUM

(71) Applicant: NEC Corporation, Tokyo (JP)

(72) Inventor: Yoshifumi HORIE, Tokyo (JP)

(73) Assignee: NEC Corporation, Tokyo (JP)

(21) Appl. No.: 19/405,508

(22) Filed: Dec. 2, 2025

(30) Foreign Application Priority Data
Dec. 17, 2024 (JP) 2024-221040

(51) Int. Cl. H04B 10/70; H04L 9/08

(52) U.S. Cl. CPC H04B 10/70; H04L 9/0819; H04L 9/0852

(57) ABSTRACT

A quantum key distribution device includes an optical modulator for modulating an optical signal and transmitting the modulated optical signal, and a controller unit for controlling the modulation. The controller controls, at a first timing, modulation of an optical signal in accordance with a first optical modulation rule in a first correspondence relationship including plural optical modulation rules each of which defines association between a first combination of a basis type and an signal state and a second combination of a value of a second bit corresponding to the basis type and a value of a first bit corresponding to the signal state, the plural optical modulation rules being different in association, and controls modulation of an optical signal in accordance with a second optical modulation rule different from the first optical modulation rule among the plural optical modulation rules of the first correspondence relationship at a second timing.

### INCORPORATION BY REFERENCE

This application is based upon and claims the benefit of priority from Japanese patent application No. 2024-221040, filed on Dec. 17, 2024, the disclosure of which is incorporated herein in its entirety by reference.

### TECHNICAL FIELD

The present disclosure relates to a quantum key distribution device, a quantum key distribution method, and a program.

### BACKGROUND ART

In the field of optical communication, research for practical application of quantum key distribution (QKD) has been conducted. A quantum key distribution system is a system that safely distributes a quantum key (common key) to remote places of two bases. In the quantum key distribution system, a transmitter (Alice) modulates an optical signal using, for example, key information and basis information, and transmits the modulated signal to a receiver (Bob) (for example, WO 2020/121451 A1).

### SUMMARY

By the way, as a threat assumed in a quantum key distribution system, there is a concern that information such as a random number and a quantum key inside a transmitter (Alice) may be estimated by measuring outside the transmitter an electromagnetic wave leaking from an electrical component of the transmitter (that is, TEMPEST attack and side-channel attack). Such a threat may reduce security of quantum key distribution.

An example object of the present disclosure is to provide a quantum key distribution device, a quantum key distribution method, and a program capable of improving security of quantum key distribution. It should be noted that the object is merely one of a plurality of objects to be achieved by a plurality of example embodiments disclosed herein. The other objects or problems and novel features will be apparent from the description of the present specification or the accompanying drawings.

A quantum key distribution device according to an example aspect of the present disclosure includes an optical modulation unit for performing modulation on an optical signal and transmitting the optical signal having undergone the modulation, and a control unit for controlling the modulation. The control unit controls, at a first timing, modulation of an optical signal by the optical modulation unit in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and controls modulation of an optical signal by the optical modulation unit in accordance with a second optical modulation rule different from the first optical modulation rule among the plurality of optical modulation rules of the first correspondence relationship at a second timing different from the first timing.

A quantum key distribution method according to an example aspect of the present disclosure is a method performed by a quantum key distribution device, including controlling modulation of an optical signal by an optical modulation unit. The controlling the modulation includes controlling, at a first timing, modulation of an optical signal in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and controlling modulation of an optical signal in accordance with a second optical modulation rule different from the first optical modulation rule among the plurality of optical modulation rules of the first correspondence relationship at a second timing different from the first timing.

A program according to an example aspect of the present disclosure causes a quantum key distribution device to execute processing including controlling modulation of an optical signal by an optical modulation unit. The controlling the modulation includes controlling, at a first timing, modulation of an optical signal in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and controlling modulation of an optical signal in accordance with a second optical modulation rule different from the first optical modulation rule among the plurality of optical modulation rules of the first correspondence relationship at a second timing different from the first timing.

According to the present disclosure, it is possible to provide a quantum key distribution device, a quantum key distribution method, and a program capable of improving security of quantum key distribution.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a system according to the present disclosure;

FIG. 2 is a block diagram illustrating an example of a quantum key distribution device according to the present disclosure;

FIG. 3 is a flowchart illustrating an example of a processing operation of the quantum key distribution device according to the present disclosure;

FIG. 4 is a block diagram illustrating another example of a quantum key distribution device according to the present disclosure;

FIG. 5 is a diagram illustrating an example of a first correspondence relationship according to the present disclosure;

FIG. 6 is a block diagram illustrating another example of a quantum key distribution device according to the present disclosure;

FIG. 7 is a diagram illustrating an example of a second correspondence relationship according to the present disclosure;

FIG. 8 is a diagram illustrating an example of synchronization of switching of a use target optical modulation rule; and

FIG. 9 is a diagram illustrating a configuration example of a quantum key distribution device.

### EXAMPLE EMBODIMENTS

Hereinafter, example embodiments will be described with reference to the drawings. Note that, in the present disclosure, the drawings can be associated with one or more example embodiments. In addition, each element of the drawings can be applied to one or more example embodiments. In addition, in the example embodiments, the same or equivalent elements are denoted by the same reference signs, and repeated description will be omitted.

### First Example Embodiment

### <Outline of System>

FIG. 1 is a diagram illustrating an example of a system according to the present disclosure. In FIG. 1, a system 1 includes a quantum key distribution device 10 and a quantum key distribution device 20. Here, it is assumed that the quantum key distribution device 10 is a transmitter (Alice) and the quantum key distribution device 20 is a receiver (Bob).

A quantum key is distributed between the quantum key distribution device 10 and the quantum key distribution device 20. For example, the quantum key is distributed by the BB84 protocol.

For example, the quantum key distribution device 10 selects a random bit string (that is, a key type) and a random basis. Then, the quantum key distribution device 10 modulates an optical signal to a signal state corresponding to a combination of a bit value and the selected basis, and transmits the modulated optical signal to the quantum key distribution device 20. The quantum key distribution device 20 selects a random basis and measures the received optical signal according to the selected basis, thereby obtaining a bit value. Then, the quantum key distribution device 10 and the quantum key distribution device 20 share a pattern of the respective bases, and share a bit value of a portion of which the bases match as a shared key.

### Configuration Example of Quantum Key Distribution Device

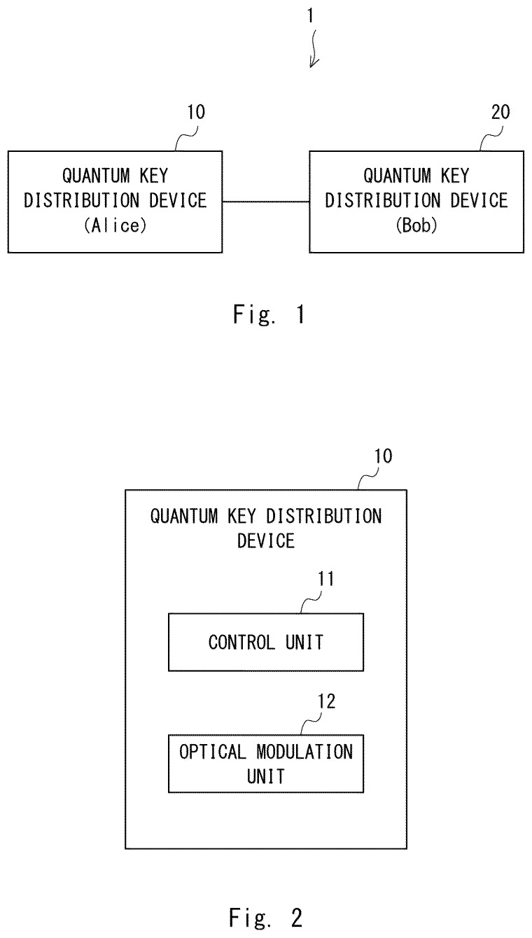

FIG. 2 is a block diagram illustrating an example of the quantum key distribution device according to the present disclosure. In FIG. 2, the quantum key distribution device 10 includes a control unit (control device) 11 and an optical modulation unit 12. Although the control unit (control device) 11 is herein described as being included in the quantum key distribution device 10, the control unit (control device) 11 may be a device independent of the quantum key distribution device 10.

The optical modulation unit 12 modulates an optical signal and transmits the modulated optical signal. For example, the optical signal may be an optical pulse.

At a first timing, the control unit 11 controls the modulation of the optical signal by the optical modulation unit 12 in accordance with a first optical modulation rule in a correspondence relationship (hereinafter, it may be referred to as a “first correspondence relationship”). The first correspondence relationship includes a plurality of “optical modulation rules”. Each optical modulation rule defines association between a first combination of a “basis type” and an “optical signal state” and a second combination of a value of a second bit corresponding to the basis type and a value of a first bit corresponding to the optical signal state. The plurality of optical modulation rules in the first correspondence relationship are different from each other in the association between the first combination and the second combination.

The control unit 11 controls the modulation of the optical signal by the optical modulation unit 12 in accordance with a second optical modulation rule different from the first optical modulation rule among the plurality of optical modulation rules in the first correspondence relationship described above, at a second timing different from the first timing.

### Operation Example of Quantum Key Distribution Device

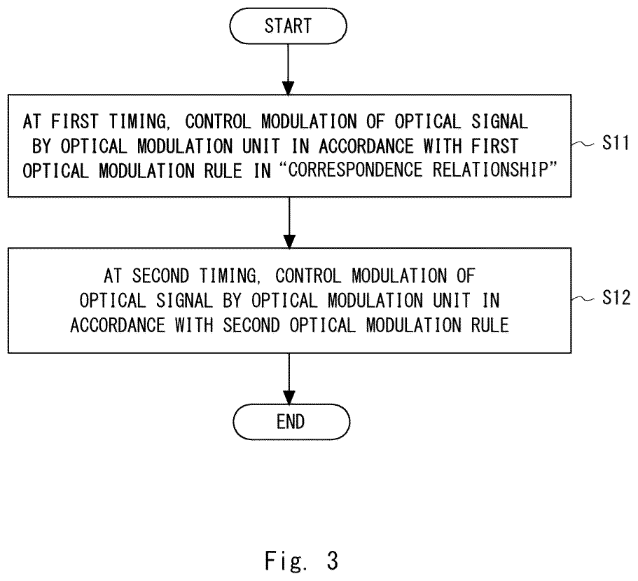

FIG. 3 is a flowchart illustrating an example of a processing operation of the quantum key distribution device according to the present disclosure. In particular, here, an example of a processing operation of the control unit (control device) 11 will be described.

At the first timing, the control unit 11 controls the modulation of the optical signal by the optical modulation unit 12 in accordance with the first optical modulation rule in the “first correspondence relationship” (step S11).

At the second timing, the control unit 11 controls the modulation of the optical signal by the optical modulation unit 12 in accordance with the second optical modulation rule (step S12).

As described above, according to the first example embodiment, in the quantum key distribution device 10, the control unit 11 controls the modulation of the optical signal by the optical modulation unit 12 in accordance with the first optical modulation rule in the “first correspondence relationship” at the first timing. The first correspondence relationship includes a plurality of “optical modulation rules”. Each optical modulation rule defines association between a first combination of a “basis type” and an “optical signal state” and a second combination of a value of a second bit corresponding to the basis type and a value of a first bit corresponding to the optical signal state. The plurality of optical modulation rules in the first correspondence relationship are different from each other in the association between the first combination and the second combination. The control unit 11 controls the modulation of the optical signal by the optical modulation unit 12 in accordance with a second optical modulation rule different from the first optical modulation rule among the plurality of optical modulation rules in the first correspondence relationship described above, at a second timing different from the first timing.

With the configuration of the quantum key distribution device 10, it is possible to modulate the optical signal in accordance with the first optical modulation rule and the second optical modulation rule that are different in the association from each other at the first timing and the second timing. Therefore, the combination of the “basis type” and the “optical signal state” corresponding to predetermined two bits at the first timing can be made different from the combination of the “basis type” and the “optical signal state” corresponding to the same predetermined two bits at the second timing. In other words, two bits corresponding to a predetermined combination of the “basis type” and the “optical signal state” at the first timing and two bits corresponding to the same predetermined combination of the “basis type” and the “optical signal state” at the second timing can be made different from each other. Therefore, even if a state of an electromagnetic wave corresponding to the predetermined combination of the “basis type” and the “optical signal state” leaked from an electrical component of the quantum key distribution device 10 is measured, it is possible to prevent the corresponding combination of two bits from being accurately estimated based on the measured state of the electromagnetic wave. As a result, security of quantum key distribution can be improved.

### Second Example Embodiment

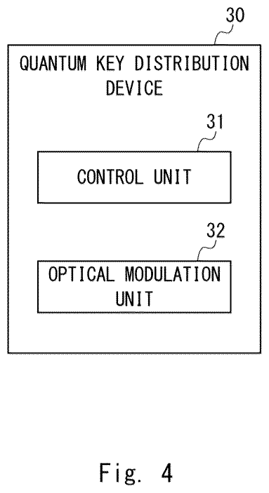

FIG. 4 is a block diagram illustrating another example of a quantum key distribution device according to the present disclosure. In FIG. 4, a quantum key distribution device 30 includes a control unit (control device) 31 and an optical modulation unit 32. Although the control unit (control device) 31 is herein described as being included in the quantum key distribution device 30, the control unit (control device) 31 may be a device independent of the quantum key distribution device 30. Since the basic configuration of a system according to the second example embodiment is the same as the system 1 according to the first example embodiment, this will be described with reference to FIG. 1. That is, a system 1 according to the second example embodiment includes the quantum key distribution device 30 instead of the quantum key distribution device 10.

Similarly to the optical modulation unit 12, the optical modulation unit 32 modulates an optical signal and transmits the modulated optical signal.

Similarly to the control unit 11, the control unit 31 switches a use target optical modulation rule (hereinafter, it may be referred to as a “first use target optical modulation rule”) among the plurality of optical modulation rules in the “first correspondence relationship”. The “first use target optical modulation rule” is an optical modulation rule set based on the first correspondence relationship. That is, the first optical modulation rule is the first use target optical modulation rule at the first timing. In addition, the second optical modulation rule is the first use target optical modulation rule at the second timing.

Then, the control unit 31 controls the modulation of the optical signal by the optical modulation unit 32 in accordance with the first use target optical modulation rule, a second random bit value designating a use target basis type, and a first random bit value designating a use target optical signal state. The second random bit value is a value of a bit included in a basis type designation random bit sequence. In addition, the first random bit value is a value of a bit included in a key type random bit sequence.

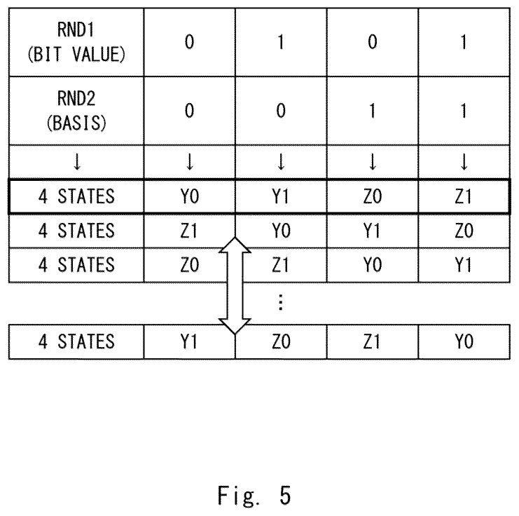

A specific example of the first correspondence relationship will be described. FIG. 5 is a diagram illustrating an example of the first correspondence relationship according to the present disclosure. In FIG. 5, the first correspondence relationship is illustrated in a table format. In FIG. 5, RAND2 corresponds to the value of the second bit corresponding to the basis type. In addition, RAND1 corresponds to the value of the first bit corresponding to the optical signal state. That is, RAND1 and RAND2 correspond to the “second combination” described above. In FIG. 5, “Y0”, “Y1”, “Z0”, and “Z1” correspond to the “first combination” of the basis type and the optical signal state described above. Then, the correspondence table of FIG. 5 holds a plurality of optical modulation rules (corresponding to a plurality of entries written as “4 states” in FIG. 5) in which correspondences between 2-bit “00”, “10”, “01”, and “11” and optical signal states “Y0”, “Y1”, “Z0”, and “Z1” are different from each other. This correspondence table is shared between the control unit (control device) 31 and the quantum key distribution device 20.

The combination of the basis type and the optical signal state includes, but is not limited to, the following.

(A) As the basis type, there are a phase basis and a time basis. As a state of an optical signal with respect to the phase basis, there are two states of a state in which a phase difference between two optical pulses of double pulses is +900 and a state in which the phase difference is −90°. In addition, as a state of an optical signal with respect to the time basis, there are two states of a state in which only a front optical pulse of the double pulses exists and a state in which only a rear optical pulse exists. For this modulation, for example, the technique disclosed in WO 2021/250829 A1 can be used.

(B) As the basis type, there are a linear basis and a circular basis. As a state of an optical signal with respect to the linear basis, there are two states of a state in which a phase of the optical signal is 0° and a state in which the phase of the optical signal is 90°. In addition, as a state of an optical signal with respect to the circular basis, there are two states of a clockwise state of the optical signal and a counterclockwise state of the optical signal.

Note that, in the following description, it is assumed that a combination of the basis type and the optical signal state corresponding to the above (A) is mainly used. In this case, the optical signal is double pulses (hereinafter, they may be referred to as a “pulse pair”). Then, in the case of the phase basis, the optical modulation unit 32 performs phase modulation on the pulse pair. Furthermore, in the case of the time basis, the optical modulation unit 32 performs intensity modulation on the pulse pair in such a way that either the front pulse or the rear pulse has 0 intensity.

The control unit 31 may periodically switch the first use target optical modulation rule in synchronization with the quantum key distribution device 20. In this switching, the first use target optical modulation rule may be selected in order from the top among the plurality of optical modulation rules in the correspondence table. Alternatively, in the case of a random number synchronization method, the control unit 31 may receive a random number for selecting the first use target optical modulation rule, and select, as the first use target optical modulation rule, an optical modulation rule having an identification number corresponding to a remainder in a case where the random number is divided by the number of optical modulation rules held in the correspondence table. In this case, similarly in the quantum key distribution device 20, the optical modulation rule having the identification number corresponding to the remainder in the case where the random number for selecting the first use target optical modulation rule is divided by the number of optical modulation rules held in the correspondence table is selected as the first use target optical modulation rule.

### Third Example Embodiment

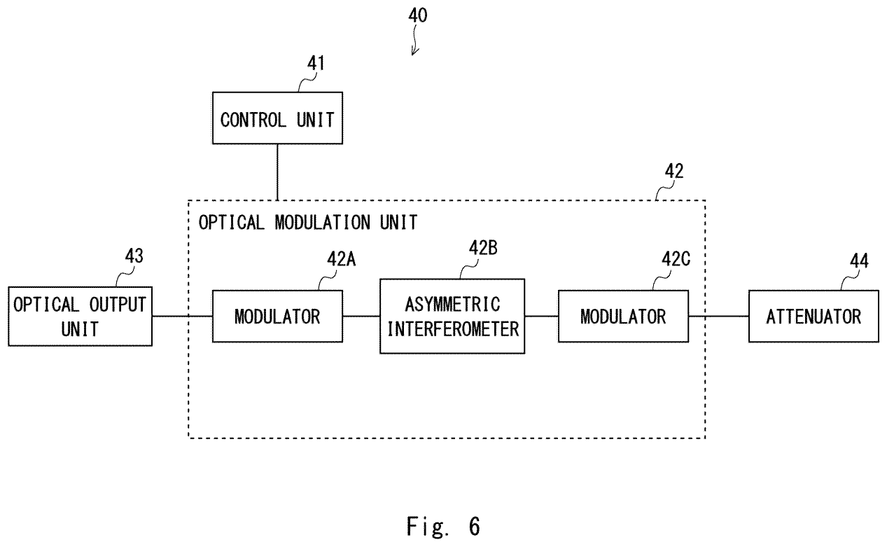

FIG. 6 is a block diagram illustrating another example of a quantum key distribution device according to the present disclosure. In FIG. 6, a quantum key distribution device 40 includes a control unit (control device) 41, an optical modulation unit 42, an optical output unit 43, and an attenuator 44. Although the control unit (control device) 41 is herein described as being included in the quantum key distribution device 40, the control unit (control device) 41 may be a device independent of the quantum key distribution device 40. Since the basic configuration of a system according to the third example embodiment is the same as the system 1 according to the first example embodiment, this will be described with reference to FIG. 1. That is, a system 1 according to the third example embodiment includes the quantum key distribution device 40 instead of the quantum key distribution device 10.

Similarly to the control unit 31, the control unit 41 switches the “first use target optical modulation rule” from among the plurality of optical modulation rules in the “first correspondence relationship”. In addition, the control unit 41 switches a “second use target optical modulation rule” from among a plurality of optical intensity modulation rules in a correspondence relationship (hereinafter, it may be referred to as a “second correspondence relationship”). The “second correspondence relationship” includes the plurality of optical intensity modulation rules. Each optical intensity modulation rule defines association between an intensity candidate of an optical signal and a bit string corresponding to the intensity candidate. The plurality of optical intensity modulation rules in the second correspondence relationship are different from each other in the association between the intensity candidate of the optical signal and the bit string corresponding to the intensity candidate.

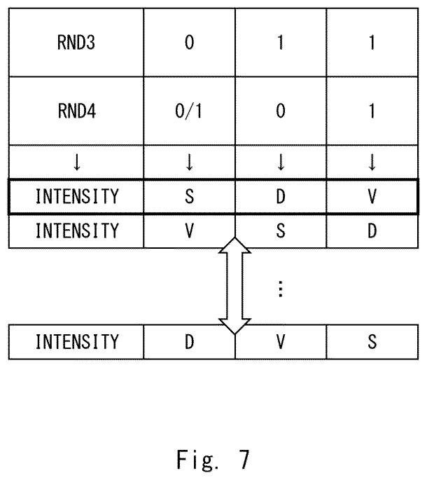

FIG. 7 is a diagram illustrating an example of the second correspondence relationship according to the present disclosure. In FIG. 7, RAND3 and RAND4 are bit strings corresponding to intensity candidates. “S” in FIG. 7 is signal light carrying key type data, and corresponds to an intensity candidate “high”. “D” is decoy light and corresponds to an intensity candidate “weak”. “V” means a vacuum, and means that an intensity is substantially zero. Then, a correspondence table of FIG. 7 holds a plurality of optical modulation rules (corresponding to a plurality of entries written as “intensity” in FIG. 7) in which correspondences between 2-bit “00 (or 01)”, “10”, and “11” and the intensity candidates “S”, “D”, and “V” are different from each other. This correspondence table is shared between the control unit (control device) 41 and the quantum key distribution device 20. For this intensity modulation, for example, the technique disclosed in WO 2021/250829 A1 can be used.

Then, similarly to the control unit 31, the control unit 41 controls the modulation of the optical signal by the optical modulation unit 42 in accordance with the first use target optical modulation rule, the second random bit value designating the use target basis type, and the first random bit value designating the use target optical signal state.

In addition, the control unit 41 controls the optical modulation unit 42 to modulate the intensity of the optical signal to an intensity corresponding to a designation bit string designating a use target optical signal intensity in the second use target modulation rule.

The optical modulation unit 42 modulates an optical signal and transmits the modulated optical signal. For example, as illustrated in FIG. 6, the optical modulation unit 42 includes a modulator 42A, an asymmetric interferometer 42B, and a modulator 42C.

The modulator 42A receives a plurality of optical pulses output from the optical output unit 43 at a predetermined cycle T. Then, the modulator 42A performs intensity modulation on each optical pulse according to the control in accordance with the second use target modulation rule by the control unit 41, and outputs the optical pulse after the intensity modulation.

The asymmetric interferometer 42B forms double pulses (pulse pair) from the optical pulse received from the modulator 42A. The asymmetric interferometer 42B has two optical waveguides having different optical path lengths. The optical pulse input to the asymmetric interferometer 42B is distributed to the two optical waveguides having the different optical path lengths to become two pulses (pulse pair). Then, the two pulses (pulse pair) are output from the asymmetric interferometer 42B at different timings (for example, with a time interval of T/2 between them).

The modulator 42C performs phase modulation or intensity modulation on each pulse pair output from the asymmetric interferometer 42B according to the control based on the first use target modulation rule by the control unit 41. The modulator 42C outputs the modulated pulse pair to the attenuator 44.

The attenuator 44 attenuates the optical intensity of the optical pulse output from the modulator 42C to a single photon level and transmits the attenuated light.

### Fourth Example Embodiment

A fourth example embodiment relates to synchronization of switching of a use target optical modulation rule. A technology related to the synchronization of the switching can be applied to any of the systems 1 of the first to third example embodiments. Here, a case where the technology related to the synchronization of the switching is applied to the system 1 of the third example embodiment will be described as an example with reference to FIGS. 1 and 6.

The quantum key distribution device 40 and the quantum key distribution device 20 of the system 1 of the third example embodiment share a bit string (hereinafter, it may be referred to as a “quantum encryption key bit string”) as a shared key by the sharing method described in the first to third example embodiments.

The control unit 41 of the quantum key distribution device 40 switches the first use target optical modulation rule and the second use target optical modulation rule in accordance with a switching rule with the quantum key distribution device 20. The “switching rule” is a rule for switching the use target optical modulation rule at a timing at which a partial bit string matching a “desired bit string pattern” appears in a case where it is confirmed whether each partial bit string matches the desired bit string pattern in a predetermined order in a plurality of partial bit strings. The plurality of partial bit strings are obtained by dividing a quantum encryption key bit string shared between the quantum key distribution device 40 and the quantum key distribution device 20 by a predetermined bit string length.

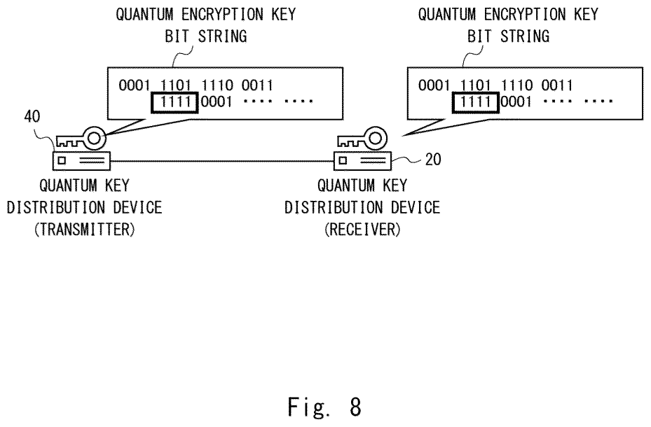

FIG. 8 is a diagram illustrating an example of synchronization of switching of a use target optical modulation rule. The quantum key distribution device 40 and the quantum key distribution device 20 hold in advance a “desired bit string pattern” for specifying a switching timing. In FIG. 8, the “desired bit string pattern” is illustrated as a 4-bit “1111”.

In a case where the quantum encryption key bit string is shared between the quantum key distribution device 40 and the quantum key distribution device 20, the control unit 41 divides the quantum encryption key bit string by a predetermined bit string length (here, four bits having the same length as the desired bit string pattern) and specifies a plurality of partial bit strings. Then, the control unit 41 confirms whether each partial bit string matches the “desired bit string pattern” in a predetermined order (for example, in order from the beginning of the quantum encryption key bit string) for each switching determination cycle. Then, the control unit 41 switches the use target optical modulation rule at a timing at which the partial bit string matching the desired bit string pattern appears. That is, in the example of FIG. 8, the control unit 41 switches the use target optical modulation rule at a timing at which the partial bit string “1111” matching the desired bit string pattern “1111” appears. Similarly to the quantum key distribution device 40, the quantum key distribution device 20 also switches the use target optical modulation rule.

By switching the use target optical modulation rule as described above, it is possible to increase randomness of the update timing while using the information of the existing quantum key distribution device.

### Other Example Embodiments

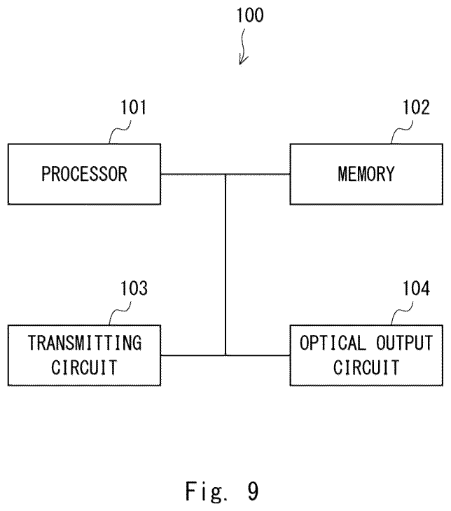

FIG. 9 is a diagram illustrating a configuration example of a quantum key distribution device. In FIG. 9, a quantum key distribution device 100 includes a processor 101, a memory 102, a transmitting circuit 103, and an optical output circuit 104. The processor 101 may be, for example, a microprocessor, a micro processing unit (MPU), or a central processing unit (CPU). The processor 101 may include a plurality of processors. The memory 102 is configured by a combination of a volatile memory and a nonvolatile memory. The memory 102 may include a storage located apart from the processor 101. In this case, the processor 101 may access the memory 102 via an input/output (I/O) interface, which is not illustrated.

Each of the quantum key distribution devices 10, 20, 30, and 40 according to the first to fourth example embodiments can have the configuration illustrated in FIG. 9. The control units (control devices) 11, 31, and 41 of the quantum key distribution devices 10, 20, 30, and 40 according to the first to fourth example embodiments may be implemented by the processor 101 reading and executing a program stored in the memory 102. That is, the quantum key distribution devices 10, 20, 30, and 40 according to the first to fourth example embodiments can be implemented by software. The optical modulation units 12, 32, and 42 and the attenuator 44 are implemented by the transmitting circuit 103. The optical output unit 43 is implemented by the optical output circuit 104. The programs can be stored using various types of non-transitory computer readable media and supplied to the quantum key distribution devices 10, 20, 30, and 40. Examples of the non-transitory computer readable medium include magnetic recording medium (for example, flexible disks, magnetic tapes, or hard disk drives), and magneto-optical recording medium (for example, magneto-optical disks). Other examples of the non-transitory computer readable media include a read only memory (CD-ROM), a CD-R, and a CD-R/W. Other examples of the non-transitory computer readable media include a semiconductor memory. Examples of the semiconductor memory include a mask ROM, a programmable ROM (PROM), an erasable PROM (EPROM), a flash ROM, and a random access memory (RAM). Furthermore, the program may be supplied to the quantum key distribution devices 10, 20, 30, and 40 by various types of transitory computer readable media. Examples of the transitory computer readable media include electrical signals, optical signals, and electromagnetic waves. The transitory computer readable medium can supply the program to the quantum key distribution devices 10, 20, 30, and 40 via a wired communication path such as an electric wire or an optical fiber, or a wireless communication path.

Alternatively, each of the control units (control devices) 11, 31, and 41 of the quantum key distribution devices 10, 20, 30, and 40 according to the first to fourth example embodiments may be implemented by dedicated hardware. In addition, some or all of the constituent components of each device may be implemented by general-purpose or dedicated circuitry, a processor, or a combination thereof. These components may be configured by a single chip, or may be configured by a plurality of chips connected to each other via a bus. Some or all of the constituent components of each device may be implemented by a combination of the above-described circuitry or the like and a program. For example, a central processing unit (CPU), a graphics processing unit (GPU), a field-programmable gate array (FPGA), or a quantum processor (quantum computer control chip) may be used as the processor.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above example embodiments can also be described as the following Supplementary Notes, but are not limited to the following.

### (Supplementary Note 1)

A quantum key distribution device including:
an optical modulation unit for performing modulation on an optical signal and transmitting the optical signal having undergone the modulation; and
a control unit for controlling the modulation,
wherein the control unit
controls, at a first timing, modulation of an optical signal by the optical modulation unit in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and
controls modulation of an optical signal by the optical modulation unit in accordance with a second optical modulation rule different from the first optical modulation rule among the plurality of optical modulation rules of the first correspondence relationship at a second timing different from the first timing.

### (Supplementary Note 2)

The quantum key distribution device according to Supplementary Note 1, wherein the control unit controls modulation of an optical signal by the optical modulation unit in accordance with a first use target optical modulation rule set based on the first correspondence relationship, a second random bit value designating a use target basis type, and a first random bit value designating a use target optical signal state.

### (Supplementary Note 3)

The quantum key distribution device according to Supplementary Note 2, wherein the control unit switches the first use target optical modulation rule from among the plurality of optical modulation rules of the first correspondence relationship.

### (Supplementary Note 4)

The quantum key distribution device according to Supplementary Note 2 or 3, wherein the control unit switches a second use target modulation rule from among a plurality of optical intensity modulation rules of a second correspondence relationship including the plurality of optical intensity modulation rules, each of the optical intensity modulation rules defining association between an intensity candidate of an optical signal and a bit string corresponding to the intensity candidate, the plurality of optical intensity modulation rules being different in the association from each other, and controls the optical modulation unit to modulate an intensity of the optical signal to an intensity corresponding to a designation bit string designating a use target optical signal intensity in the second use target modulation rule.

### (Supplementary Note 5)

The quantum key distribution device according to Supplementary Note 2 or 3, wherein
the second random bit value is a value of a bit included in a basis type designation random bit sequence, and
the first random bit value is a value of a bit included in a key type random bit sequence.

### (Supplementary Note 6)

The quantum key distribution device according to Supplementary Note 3, wherein
the control unit switches the first use target optical modulation rule in accordance with a switching rule with a receiving-end device of the optical signal transmitted, and
the switching rule is a rule for switching the first use target optical modulation rule at a timing at which a partial bit string matching a desired bit string pattern appears in a case where it is confirmed whether each partial bit string matches the desired bit string pattern in a predetermined order in a plurality of partial bit strings obtained by dividing a quantum encryption key bit string shared with the receiving-end device by a predetermined bit string length.

### (Supplementary Note 7)

The quantum key distribution device according to Supplementary Note 3, wherein the control unit switches the first use target optical modulation rule periodically in synchronization with a receiving-end device of the optical signal having undergone the modulation.

### (Supplementary Note 8)

A method performed by a quantum key distribution device, including controlling modulation of an optical signal by an optical modulation unit,
wherein the controlling the modulation includes
controlling, at a first timing, modulation of an optical signal in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and
controlling modulation of an optical signal in accordance with a second optical modulation rule different from the first optical modulation rule among the plurality of optical modulation rules of the first correspondence relationship at a second timing different from the first timing.

### (Supplementary Note 9)

The quantum key distribution method according to Supplementary Note 8, wherein the controlling the modulation includes controlling modulation of an optical signal by the optical modulation unit in accordance with a first use target optical modulation rule set based on the first correspondence relationship, a second random bit value designating a use target basis type, and a first random bit value designating a use target optical signal state.

### (Supplementary Note 10)

The quantum key distribution method according to Supplementary Note 9, wherein the controlling the modulation includes switching the first use target optical modulation rule from among the plurality of optical modulation rules of the first correspondence relationship.

### (Supplementary Note 11)

The quantum key distribution method according to Supplementary Note 9 or 10, wherein the controlling the modulation includes switching a second use target modulation rule from among a plurality of optical intensity modulation rules of a second correspondence relationship including the plurality of optical intensity modulation rules, each of the optical intensity modulation rules defining association between an intensity candidate of an optical signal and a bit string corresponding to the intensity candidate, the plurality of optical intensity modulation rules being different in the association from each other, and controlling the optical modulation unit to modulate an intensity of the optical signal to an intensity corresponding to a designation bit string designating a use target optical signal intensity in the second use target modulation rule.

### (Supplementary Note 12)

The quantum key distribution method according to Supplementary Note 9 or 10, wherein
the second random bit value is a value of a bit included in a basis type designation random bit sequence, and
the first random bit value is a value of a bit included in a key type random bit sequence.

### (Supplementary Note 13)

The quantum key distribution method according to Supplementary Note 10, wherein
the controlling the modulation includes switching the first use target optical modulation rule in accordance with a switching rule with a receiving-end device of the optical signal having undergone the modulation, and
the switching rule is a rule for switching the first use target optical modulation rule at a timing at which a partial bit string matching a desired bit string pattern appears in a case where it is confirmed whether each partial bit string matches the desired bit string pattern in a predetermined order in a plurality of partial bit strings obtained by dividing a quantum encryption key bit string shared with the receiving-end device by a predetermined bit string length.

### (Supplementary Note 14)

The quantum key distribution method according to Supplementary Note 10, wherein the controlling the modulation includes switching the first use target optical modulation rule periodically in synchronization with a receiving-end device of the optical signal having undergone the modulation.

### (Supplementary Note 15)

A program for causing a quantum key distribution device to execute processing including controlling modulation of an optical signal by an optical modulation unit,
wherein the controlling the modulation includes
controlling, at a first timing, modulation of an optical signal in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and
controlling modulation of an optical signal in accordance with a second optical modulation rule different from the first optical modulation rule among the plurality of optical modulation rules of the first correspondence relationship at a second timing different from the first timing.

### (Supplementary Note 16)

The program according to Supplementary Note 15, wherein the controlling the modulation includes controlling modulation of an optical signal by the optical modulation unit in accordance with a first use target optical modulation rule set based on the first correspondence relationship, a second random bit value designating a use target basis type, and a first random bit value designating a use target optical signal state.

### (Supplementary Note 17)

The program according to Supplementary Note 16, wherein the controlling the modulation includes switching the first use target optical modulation rule from among the plurality of optical modulation rules of the first correspondence relationship.

### (Supplementary Note 18)

The program according to Supplementary Note 16 or 17, wherein the controlling the modulation includes switching a second use target modulation rule from among a plurality of optical intensity modulation rules of a second correspondence relationship including the plurality of optical intensity modulation rules, each of the optical intensity modulation rules defining association between an intensity candidate of an optical signal and a bit string corresponding to the intensity candidate, the plurality of optical intensity modulation rules being different in the association from each other, and controlling the optical modulation unit to modulate an intensity of the optical signal to an intensity corresponding to a designation bit string designating a use target optical signal intensity in the second use target modulation rule.

### (Supplementary Note 19)

The program according to Supplementary Note 16 or 17, wherein
the second random bit value is a value of a bit included in a basis type designation random bit sequence, and
the first random bit value is a value of a bit included in a key type random bit sequence.

### (Supplementary Note 20)

The program according to Supplementary Note 17, wherein
the controlling the modulation includes switching the first use target optical modulation rule in accordance with a switching rule with a receiving-end device of the optical signal having undergone the modulation, and
the switching rule is a rule for switching the first use target optical modulation rule at a timing at which a partial bit string matching a desired bit string pattern appears in a case where it is confirmed whether each partial bit string matches the desired bit string pattern in a predetermined order in a plurality of partial bit strings obtained by dividing a quantum encryption key bit string shared with the receiving-end device by a predetermined bit string length.

### (Supplementary Note 21)

The program according to Supplementary Note 17, wherein the controlling the modulation includes switching the first use target optical modulation rule periodically in synchronization with a receiving-end device of the optical signal having undergone the modulation.

What is claimed is:

1. A quantum key distribution device comprising:
a transmitting circuit configured to perform modulation on an optical signal and transmit the optical signal having undergone the modulation;
at least one memory storing instructions, and
at least one processor configured to execute the instructions to;
control, at a first timing, modulation of an optical signal by the transmitting circuit in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and
control modulation of an optical signal by the transmitting circuit in accordance with a second optical modulation rule different from the first optical modulation rule among the plurality of optical modulation rules of the first correspondence relationship at a second timing different from the first timing.

2. The quantum key distribution device according to claim 1, wherein the at least one processor controls modulation of an optical signal by the transmitting circuit in accordance with a first use target optical modulation rule set based on the first correspondence relationship, a second random bit value designating a use target basis type, and a first random bit value designating a use target optical signal state.

3. The quantum key distribution device according to claim 2, wherein the at least one processor switches the first use target optical modulation rule from among the plurality of optical modulation rules of the first correspondence relationship.

4. The quantum key distribution device according to claim 2, wherein the at least one processor switches a second use target modulation rule from among a plurality of optical intensity modulation rules of a second correspondence relationship including the plurality of optical intensity modulation rules, each of the optical intensity modulation rules defining association between an intensity candidate of an optical signal and a bit string corresponding to the intensity candidate, the plurality of optical intensity modulation rules being different in the association from each other, and controls the transmitting circuit to modulate an intensity of the optical signal to an intensity corresponding to a designation bit string designating a use target optical signal intensity in the second use target modulation rule.

5. The quantum key distribution device according to claim 2, wherein
the second random bit value is a value of a bit included in a basis type designation random bit sequence, and
the first random bit value is a value of a bit included in a key type random bit sequence.

6. The quantum key distribution device according to claim 3, wherein
the at least one processor switches the first use target optical modulation rule in accordance with a switching rule with a receiving-end device of the optical signal transmitted, and
the switching rule is a rule for switching the first use target optical modulation rule at a timing at which a partial bit string matching a desired bit string pattern appears in a case where it is confirmed whether each partial bit string matches the desired bit string pattern in a predetermined order in a plurality of partial bit strings obtained by dividing a quantum encryption key bit string shared with the receiving-end device by a predetermined bit string length.

7. The quantum key distribution device according to claim 3, wherein the at least one processor switches the first use target optical modulation rule periodically in synchronization with a receiving-end device of the optical signal having undergone the modulation.

8. A method performed by a quantum key distribution device, comprising controlling modulation of an optical signal by a transmitting circuit,
wherein the controlling the modulation includes
controlling, at a first timing, modulation of an optical signal in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and
controlling modulation of an optical signal in accordance with a second optical modulation rule different from the first optical modulation rule among the plurality of optical modulation rules of the first correspondence relationship at a second timing different from the first timing.

9. A non-transitory computer readable medium storing a program for causing a quantum key distribution device to execute processing including controlling modulation of an optical signal by a transmitting circuit,
wherein the controlling the modulation includes
controlling, at a first timing, modulation of an optical signal in accordance with a first optical modulation rule in a first correspondence relationship including a plurality of optical modulation rules, each of the optical modulation rules defining association between a first combination of a basis type and an optical signal state and a second combination of a value of a second bit corresponding to the basis type and a value of a first bit corresponding to the optical signal state, the plurality of optical modulation rules being different in the association from each other, and
controlling modulation of an optical signal in accordance with a second optical modulation rule different from the first optical modulation rule among the plurality of optical modulation rules of the first correspondence relationship at a second timing different from the first timing.
